(19) United States
(12) Patent Application Publication
(10) Pub. No.: US 2008/0289386 A1
(43) Pub. Date: Nov. 27, 2008

(54) Extended Release Compositions

(75) Inventors: Murray Zander, Auckland (NZ); Mike Brown, Hamilton (NZ)

Correspondence Address: GREER, BURNS & CRAIN, 300 S WACKER DR, 25TH FLOOR, CHICAGO, IL, 60606, US

(73) Assignee: HI TECH PRODUCTS LIMITED, Te Awamutu (NZ)

(21) Appl. No.: 11/660,467

(22) PCT Filed: Jul. 6, 2005
(86) PCT No.: PCT/NZ05/00162

§ 371 Date: Apr. 1, 2008

(30) Foreign Application Priority Data
Aug. 16, 2004 (NZ) 534753

(51) Int. Cl. C05B 7/00; C05D 9/02

(52) U.S. Cl. 71/36; 71/33

(57) ABSTRACT

Extended release compositions containing selenium and methods of using such compositions in the treatment of soil deficient in selenium are provided. For example, the composition could comprise sodium selenium and acidulated phosphate.

### TECHNICAL FIELD

The present invention relates to extended release compositions. Particularly, although not exclusively, the present invention relates to extended release compositions containing selenium and methods of using such compositions in the treatment of soil deficient in selenium.

### BACKGROUND ART

Selenium is a trace element essential to the well-being of animals and plants. However, many pastures and soils are deficient in selenium. Animals feeding on selenium deficient pastures often display symptoms such as ill-thrift, and in the case of sheep, the deficiency can adversely affect ewe fertility and increase lamb mortality.

Selenium deficiency in stock has historically been corrected by the administration of a drench containing sodium selenate to the stock. Sodium selenate is, however, extremely toxic. The high toxicity means that very small doses must be applied and drenching must therefore be carried out with high frequency. Such labour intensive treatment methods are far from economical.

Another method for addressing selenium deficiency in grazing animals involves the application of sodium selenate directly to pastures. The selenium is taken up by plants and is thereby made available to grazing animals. Pasture selenium levels rise very rapidly following direct application. However available sodium selenate levels decline at a rate faster than desired due to leaching from the soil and luxury plant uptake.

Selenium blood levels of the grazing stock may remain above the deficiency level throughout the 12 month period following direct pasture application. However, this is not always the case with infant stock that are being weaned. Due to the importance of selenium for growth and development in young live stock, frequent drenching may still be required to provide sufficient blood selenium levels in these weaning infants.

New Zealand Patent Number 214840 discloses the use of a barium selenate containing formulation. Barium selenate, like barium sulphate, is quite insoluble in water. The use of this insoluble salt results in a composition from which selenium may be released into pasture at a controlled rate. Although the concentrations used are generally low, barium is toxic. It would therefore be useful if there were an alternative method of providing a controlled release selenium formulation.

It is an object of the present invention to provide a formulation which addresses the problems highlighted herein with the prior art methods and/or formulations or at the very least to provide the public and the trade with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided an extended release composition comprising an acidulated phosphate and a source of selenate.

The term ‘phosphate’ refers to the PO₄³⁻ ion or to any compound containing this ion.

The acidulated phosphate may be diammonium phosphate, monammonium phosphate, super-phosphate, and triple super-phosphate or any other suitably acidulated phosphate.

For ease of reference only the ‘acidulated phosphate’ will no be referred to simply as phosphate.

In preferred embodiments the phosphate may be super-phosphate.

The phosphate may be acidulated by any organic or inorganic acid in any amount. More desirable extended release properties may result from increased acidulation of the phosphate.

In preferred embodiments the phosphate may be acidulated by the addition of an inorganic acid.

In particularly preferred embodiments the phosphate may be acidulated by phosphoric acid.

The phosphate may be in the form of a powder, a granule, a pellet or any other solid form. The phosphate may be of any size and any size distribution and may contain anions other than phosphate as well as water and other impurities.

In preferred embodiments the phosphate may be in the form of a granule.

In particularly preferred embodiments the phosphate may be in the form of a granule having an average size of about 1 mm to about 5 mm in diameter.

The term ‘selenate’ refers to the SeO₄²⁻ ion or a compound containing this ion.

The source of selenate ions may comprise any cation or cations combined with selenate ions so long as the resultant salt is at least partially water soluble. In some embodiments the cation(s) may be physiologically tolerable, for example ammonium or sodium. However, as the invention contemplates use in very small quantities and/or uses in fields other than animal husbandry, some embodiments of the invention may comprise cations which may otherwise be considered toxic.

In preferred embodiments the selenate source is sodium selenate.

In a further aspect the present invention provides a method for increasing the selenium concentration of a substrate comprising applying to the substrate an extended release composition as herein defined.

In a further aspect the present also provides a method for manufacturing an extended release composition comprising the steps of:
mixing a source of selenate with a suitable solvent to create a selenate source-solvent mixture; and
exposing an acidulated phosphate to the selenate source-solvent mixture.

The step of mixing a source of selenate with a suitable solvent may involve any method of mixing but in preferred embodiments involves stirring the source of selenate with the solvent for a predetermined time. The source of selenium ions need not completely dissolve in the solvent and indeed incomplete dissolution of the source of selenium ions in the solvent results in some of the source of selenium ions being present which cannot penetrate into the acidulated phosphate once added to the mixture. Extended release formulations made using an incompletely dissolved source of selenium ions may thereby provide desirable extended release profiles due to some of the selenate being available at the surface of the acidulated phosphate.

The suitable solvent may be any liquid in which an amount of the source of selenium ions may be dissolved. One of skill in the art will be able to determine which solvents are suitable for use in the method of the present invention without undue experimentation and without having any additional inventive input of their own.

In preferred embodiments the solvent may be water.

In particularly preferred embodiments the solvent may be hot water.

Preferred embodiments of the method of manufacture may comprise the additional step of coating the acidulated phosphate/selenium composition with one or more other inorganic materials.

In preferred embodiments the inorganic material may be alkaline.

In particularly preferred embodiments the inorganic material may be lime and/or magnesium oxide.

In these embodiments the lime or magnesium oxide may react with acid present in the mixture to produce heat and may therefore aid in the drying of the product.

The step of exposing an acidulated phosphate to the selenate source-solvent mixture may include all of those methods of mixing a liquid and a solid known in the art including spraying the selenate source-solvent mixture on to the acidulated phosphate, and adding the selenate source-solvent mixture simply by pouring it over the acidulated phosphate. This step may be carried out using a rotary mixer or any other mixing apparatus.

In preferred embodiments the step of exposing an acidulated phosphate to the selenate source-solvent mixture includes pouring the selenate source-solvent mixture slowly onto the acidulated phosphate whilst mixing in a rotary mixer.

Preferred embodiments of the method of manufacture comprise the additional step of removing some or all of the solvent from the composition.

The step of removing the solvent from the composition may take the form of fluidised bed drying and the like or simply allowing the product to stand.

In some embodiments the product may be additionally coated with one or more agents to prevent contamination during handling. The contamination preventing agents may be any substance that can form a barrier between selenate absorbed on the surface of the acidulated phosphate and the environment at large. Those agents may be water soluble gums, polymers, or other suitable materials.

In preferred embodiments the product may be additionally coated with one or more vegetable gums and/or one or more flocculants.

The present invention also provides a method for increasing the selenium concentration of a substrate comprising applying to the substrate an extended release composition manufactured according to the method as herein defined.

The preferred embodiments of the present invention may have a number of advantages over the prior art which may include:
the ease with which the product may be manufactured and applied;
the cost of production and application, and
the relative increase in available selenium and low toxicity of the resulting formulation once applied over an area of land.

### BRIEF DESCRIPTION OF DRAWINGS

Further aspects of the present invention will become apparent from the following description which is given by way of example only and with reference to the accompanying drawings in which:

FIG. 1 is a graph showing the effect of selenium fertiliser treatments on pasture selenium concentrations (bars represent±standard errors);

FIG. 2 is a graph showing the effect of selenium fertiliser treatments on cumulative selenium uptake (bars represent±standard errors);

FIG. 3 is a table showing soluble and insoluble selenium levels for various example compositions according to the invention (30 Jun. 2004);

FIG. 4 is a table showing soluble and insoluble selenium levels for various example compositions according to the invention after storage (16 Jul. 2004); and

FIG. 5 is a table showing soluble and insoluble selenium levels for various example compositions according to the invention after further storage (29 Jul. 2004).

### BEST MODES FOR CARRYING OUT THE INVENTION

### Example 1

### Code-NG3

Fresh super-phosphate granules (7 kg) were added to a rotary mixer and the mixer was started at a medium speed. Sodium selenate (520 g) was dissolved in hot (65° C.) water (500 mL) and added to the super-phosphate over around 10 seconds. Mixing was continued until the granules assumed uniform flow characteristics again. A sample of the treated granules was retained for testing.

### Example 2

### Code-NG4

Fresh super-phosphate granules (7 kg) were added to a rotary mixer and the mixer was started at a medium speed. Sodium selenate (520 g) was dissolved in hot (65° C.) water (500 mL) and added to the super-phosphate over around 10 seconds. Mixing was continued until the granules assumed uniform flow characteristics (around 2-3 minutes). Powdered magnesium oxide (175 g) was added to the ‘selenated’ granules and mixing was continued until the granules assumed uniform flow characteristics again. A sample of the treated granules was retained for testing.

### Example 3

### Code-NG2

Fresh super-phosphate granules (7 kg) and powdered magnesium oxide (175 g) were added to a rotary mixer and the mixer was started at a medium speed. Sodium selenate (520 g) was dissolved in hot (65° C.) water (500 mL) and added to the super-phosphate over around 10 seconds. Mixing was continued until the granules assumed uniform flow characteristics again. A sample of the treated granules was retained for testing.

### Example 4

### Code NG2/P

The product from example 3 above (2 kg) was mixed in the rotary mixer with a solution of liquid magnafloc/xanthan gum (5 g) in water (5 mL). Mixing was continued until the granules assumed uniform flow characteristics again and a sample of the treated granules was retained for testing.

### Example 5

### Code-NG1

Fresh super-phosphate granules (7 kg) and powdered magnesium oxide (175 g) were added to a rotary mixer and the mixer was started at a medium speed. Sodium selenate (520 g) was dissolved in hot (65° C.) water (500 mL) and added to the super-phosphate over around 10 seconds. Mixing was continued until the granules assumed uniform flow characteristics. Water (300 mL) was added and mixing continued. Lime (2 kg) and magnesium oxide (575 g) was added slowly to the mixer followed by more water (200 mL). Mixing was continued until the granules assumed uniform flow characteristics again and a sample of the treated granules was retained for testing.

### Example 6

### Code-P1

Fresh super-phosphate granules (7 kg) and powdered magnesium oxide (175 g) were added to a rotary mixer and the mixer was started at a medium speed. Sodium selenate (520 g) was dissolved in hot (65° C.) water (500 mL) and added to the super-phosphate over around 10 seconds. Mixing was continued until the granules assumed uniform flow characteristics. Lime (500 g) and magnesium oxide (145 g) was added slowly to the mixer. Water (300 mL) containing magnafloc/xanthan gum (20 g) was added and mixing continued. Lime (1.5 kg) and magnesium oxide (430 g) was added slowly to the mixer. Mixing was continued until the granules assumed uniform flow characteristics again and a sample of the treated granules was retained for testing. This composition is referred to as Hi-Tech Prill B in the trials work.

### Example 7

### Code-P2

Fresh super-phosphate granules (8.5 kg) and powdered magnesium oxide (175 g) were added to a rotary mixer and the mixer was started at a medium speed. Sodium selenate (520 g) was dissolved in hot (65° C.) water (500 mL) and added to the super-phosphate over around 10 seconds. Mixing was continued until the granules assumed uniform flow characteristics. Water (300 mL) containing magnafloc/xanthan gum (20 g) was added and mixing continued. Lime (500 g) and magnesium oxide (475 g) was added slowly to the mixer. Mixing was continued until the granules assumed uniform flow characteristics again and a sample of the treated granules was retained for testing.

### Example 8

### Code-P3

Fresh super-phosphate granules (7 kg) and powdered magnesium oxide (175 g) were added to a rotary mixer and the mixer was started at a medium speed. Sodium selenate (260 g) was dissolved in hot (65° C.) water (300 mL) and added to the super-phosphate over around 10 seconds. Mixing was continued until the granules assumed uniform flow characteristics. Lime (500 g) and magnesium oxide (145 g) was added slowly to the mixer. Water (300 mL) containing magnafloc/xanthan gum (20 g) was added and mixing continued. Lime (1.5 kg) and magnesium oxide (430 g) was added slowly to the mixer. Mixing was continued until the granules assumed uniform flow characteristics again and a sample of the treated granules was retained for testing. This composition is referred to as Hi-Tech Prill A in the trials work.

### Example 9

### Code-P4

Fresh super-phosphate granules (7 kg) and powdered magnesium oxide (175 g) were added to a rotary mixer and the mixer was started at a medium speed. Sodium selenate (520 g) was dissolved in hot (85° C.) water (500 mL) and added to the super-phosphate over around 10 seconds. Mixing was continued until the granules assumed uniform flow characteristics. Lime (500 g) and magnesium oxide (145 g) was added slowly to the mixer. Water (300 mL) containing magnafloc/xanthan gum (20 g) was added and mixing continued. Lime (1.5 kg) and magnesium oxide (430 g) was added slowly to the mixer. Mixing was continued until the granules assumed uniform flow characteristics again and a sample of the treated granules was retained for testing.

Magnafloc is a cationic polyelectrolyte flocculant manufactured by Ciba Specialty Chemicals.

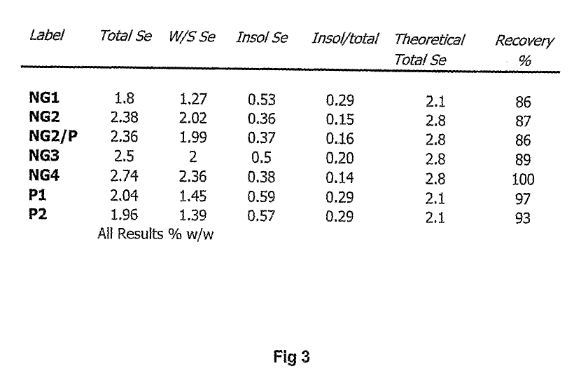

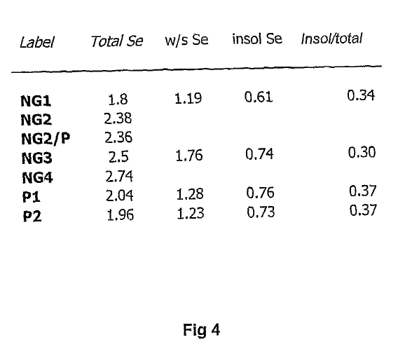

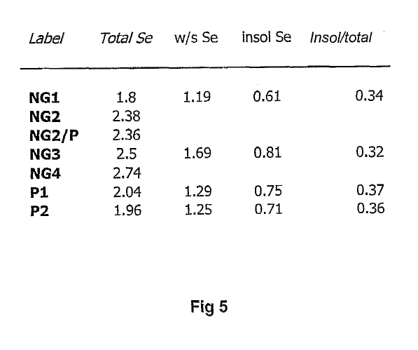

FIGS. 3, 4 and 5 show total selenium, water soluble selenium, and insoluble selenium levels obtained experimentally for samples prepared as outlined in the Examples. After approximately two weeks of storage insoluble selenium levels had increased in all samples measured at the expense of water soluble selenium. After a month NG1, P1, and P2 were approximately the same as after two weeks but NG3 can be seen to have increased further to 0.81% insoluble selenium by weight. NG3 is the only sample without magnesium oxide added that has testing data available. Phosphoric acid or water still in the granule may be continuing to react with added selenate to form an insoluble complex.

### Testing

Compositions according to the present invention were tested on the North Block of the Lincoln University dairy farm, on free-draining Templeton (sandy) soils. The filed trial consisted of plots (2×5 m) in a completely randomized design.

### Selenium Treatments

The selenium treatments were applied to the plots on 24 Oct. 2003 and consist of:

1. Control (no selenium)
2. Selenium chip, SeChip (1%) at 1.0 kg/ha
3. Selcote Ultra at 1.0 kg/ha
4. Hi-Tech Prill A at 1.0 kg/ha (P3)
5. Hi-Tech Prill B at 0.5 kg/ha (P1)

There were 6 replicate plots for each of the treatments and 4 replicates for the control (28 plots in total).

In order to carry out the comparison between materials under as uniform conditions as possible (in terms of granule size and distribution pattern), each fertilizer was sieved to collect granules between 1 and 2.8 mm diameter for use in the trial. As far as possible, the granules were placed carefully on the plots in a regular grid pattern. Basal nutrients were applied with the normal farm fertilizer applications.

### Herbage Selenium Concentrations

The trial was conducted under centre pivot irrigation, with grazing animals excluded. Samples of the herbage were harvested as indicated in the following table:

| Harvest No. | Date |
|---|---|
| 1 | 19 Nov. 2003 |
| 2 | 15 Dec. 2003 |
| 3 | 5 Jan. 2004 |
| 4 | 3 Feb. 2004 |
| 5 | 4 Mar. 2004 |
| 6 | 30 Mar. 2004 |
| 7 | 10 Jun. 2004 |
| 8 | 22 Sep. 2004 |
| 9 | 22 Oct. 2004 |

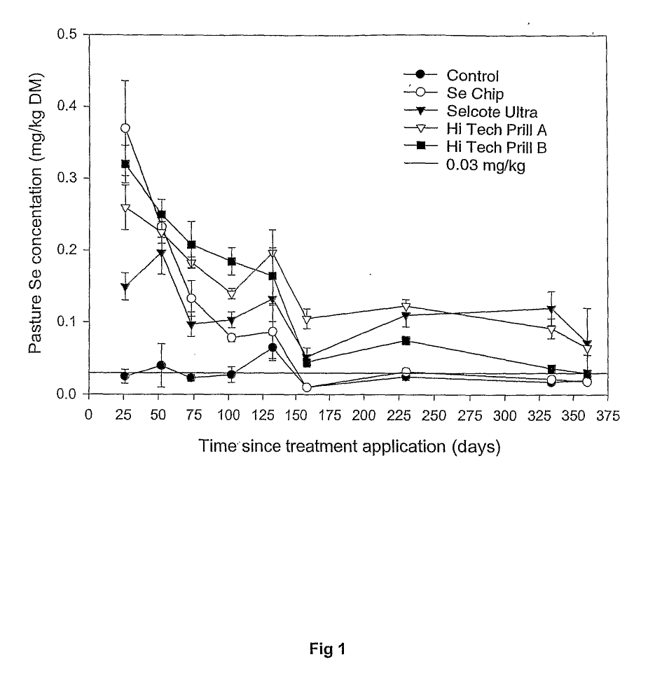

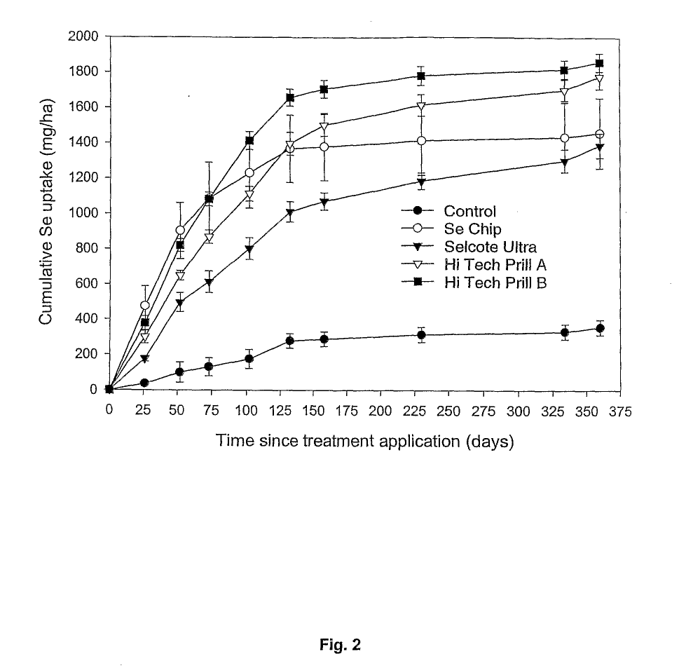

Harvested samples were then analysed to give the selenium levels plotted in the graphs appended as FIGS. 1 and 2.

All four selenium treatments have increased herbage selenium concentrations relative to the control. Apart from the first sampling, the products according to the present invention (Hi-Tech) products generally produced higher herbage selenium concentrations than the other products although the differences are not always statistically significant.

The herbage selenium concentrations obtained with all four products have decreased with time although the decrease appears fastest for the SeChip chip treatment. At the fifth harvest, herbage selenium concentrations for all four products still remain above the concentration in the control, however, except for the Hi-Tech Prill A material, the difference are not statistically significant.

The cumulative selenium uptakes (mg Se/ha) for the first five harvests of each of the treatments are shown in FIG. 2. Uptakes are calculated from the selenium concentrations and dry matter yields from the plots. Dry matter production for the first five harvests was approximately 7500 kg/ha.

All four selenium fertilizer treatments show substantial increased cumulative selenium uptake by pasture compared to the control. By the fifth harvest, the compositions of the present invention (Hi-Tech Prill B) shows the greatest cumulative selenium uptake and the Selcote Ultra product the smallest. Cumulative uptake from the Hi-Tech Prill A and SeChip chip products are similar to each other, and are intermediate between the values for Hi-Tech Prill B and Selcote Ultra. However, the rate of increase for the SeChip chip product appears to have stagnated somewhat. The last five points on the graph for the SeChip chip appear to indicate that all of the selenium had already leached from the granule at around 130 days. Cumulative uptake was highest in the Hi-Tech Prill A and Prill B test sites.

At the final cut, and as shown in FIG. 1, the SeChip and Hi-Tech Prill B are not significantly different from the control pasture selenium concentrations. Selcote Ultra and Hi-Tech Prill A are still significantly higher than control giving values of 72 mg and 65 mg per kilo, respectively.

During production of the compositions according to the present invention sodium selenate is preferably dissolved in warm water. During laboratory studies it has been found that the temperature of the water used during production of the compositions approximately correlates with the amount of insoluble selenium in the final product. The higher the temperature used, the less water soluble selenium there is in the final composition. Highly preferred compositions according to the present invention may therefore be manufactured using water of 75° C. or warmer.

Aspects of the present invention have been described by way of example only and it should be appreciated that modifications and additions may be made thereto without departing from the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

24. (canceled)

25. (canceled)

26. (canceled)

27. (canceled)

28. (canceled)

29. (canceled)

30. (canceled)

31. (canceled)

32. A composition for application to land comprising an acidulated phosphate formulated for extended release and a source of selenate.

33. A composition according to claim 32, wherein the acidulated phosphate is selected from the group consisting of: diammonium phosphate, monammonium phosphate, super-phosphate, and triple super-phosphate.

34. A composition according to claim 32, wherein the acidulated phosphate is super-phosphate.

35. A composition according to claim 32, wherein the acidulated phosphate is in the form of granules.

36. A composition according to claim 35, wherein the granules have an average diameter of from about 1 mm to about 5 mm.

37. A composition according to claim 32, wherein the acidulated phosphate is acidulated by virtue of the inclusion of an inorganic acid selected from the group consisting of phosphoric acid, sulphuric acid, nitric acid and hydrohalic acid.

38. A composition according to claim 37, wherein the acidulated phosphate is acidulated by virtue of the inclusion of phosphoric acid.

39. A composition according to claim 32, wherein the source of selenate is ammonium selenate.

40. A composition according to claim 32, wherein the source of selenate is sodium selenate.

41. A method for manufacturing an extended release composition for application to pasture land comprising the steps of:
mixing a source of selenate with a solvent to create a selenate source-solvent mixture; and
mixing an acidulated phosphate to the selenate source-solvent mixture.

42. A method according to claim 41, wherein the solvent is water.

43. A method according to claim 41, wherein the solvent is water having a temperature above substantially 50° C.

44. A method according to claim 41, wherein the solvent is water having a temperature above substantially 75° C.

45. A method according to claim 41, wherein the method further comprises the step of coating the extended release composition with one or more other inorganic materials.

46. A method according to claim 45, wherein the inorganic material is alkaline.

47. A method according to claim 46, wherein the inorganic material is lime or magnesium oxide.

48. A method according to claim 46, wherein the inorganic material is a mixture of lime and magnesium oxide.

49. A method according to claim 41, wherein the step of exposing an acidulated phosphate to the selenate source-solvent mixture takes place in a rotary mixer.

50. A method according to claim 41, comprising the additional step of removing at least some, or all of, the solvent from the composition.

51. A method according to claim 41, comprising the additional step of coating the composition with one or more contamination preventing agents.

52. A method according to claim 51, wherein the agents are selected from water soluble gums, other vegetable gums, polymers and flocculants.

53. A method according to claim 52, wherein more than one of the agents are applied together to the composition.

54. A method for increasing the selenium concentration of a substrate comprising applying to said substrate an extended release composition according to claim 32.

55. A method for increasing the selenium concentration of a substrate comprising applying to said substrate a composition manufactured according to the method of claim 41.

56. A method according to claim 54, wherein the substrate is an area of land.
